(19) United States
(12) Patent Application Publication
(10) Pub. No.: US 2003/0074231 A1
(43) Pub. Date: Apr. 17, 2003

(54) Insurance for cessation of legal personal contract

(76) Inventors: Johan Renes, Soest (NL); Allen C. Turner, Salt Lake City, UT (US)

Correspondence Address: TRASK BRITT, P.O. BOX 2550, SALT LAKE CITY, UT, 84110, US

(21) Appl. No.: 09/981,213

(22) Filed: Oct. 17, 2001

(51) Int. Cl. G06F 17/60

(52) U.S. Cl. 705/4

(57) ABSTRACT

A method of doing business in divorce insurance policies, which method includes determining a periodic (e.g., monthly, semi-annually or annually) amount to be charged a prospective participant for divorce insurance; charging that periodic amount to a participant in an insurance program over a period of time; and administering the insurance program (e.g., confirm that a divorce has or has not occurred, receiving and making payments, etc.). The amount to be charged a prospective participant will generally be based upon the prospective participant's age and the prospective participant's spouse's age, both at the time of the marriage and at the time of paying the particular premium. The amount to be charged will also typically be based, in part, on the prospective participant's projected earnings and/or the prospective participant's spouse's projected earnings. The amount charged a participant can be changed in view of changed circumstances in the lifestyle (e.g., income, inflation, deflation, educational achievement of the participant or the participant's spouse, birth of a child, death of a child, disability of a participant, disability of a spouse, return on investment) of the participant. Once determined and collected, at least a portion of the periodic amount will be invested by the insurance company in appropriate investments.

### TECHNICAL FIELD

The present invention relates to the field of insurance, particularly insurance covering financial consequences of termination of contracts, be it through breach or mutual consent of the contracting parties or for other reasons. More particularly, the invention relates to businesses and business methods (e.g., insurance) generally, and to divorce insurance especially.

### BACKGROUND

An unfortunate event in the life of many is a break up, separation or divorce. Sometimes, couples get married too early, sometimes after marrying they fall in love with someone else, sometimes the couple suffers a tragedy such as the loss of a child, and sometimes they suffer financial difficulties which make life together difficult, the couple breaks up. Whatever the reason behind a couple's divorce, there are generally serious financial consequences. This situation even extends to couples who are not married, but who are living together where “palimony” may be awarded.

Part of the financial problem associated with divorce is that associated with any children the couple might have. Now, instead of the family salary supporting one household, it must support two with various redundancies in needs (e.g., rent, electricity, utilities). Even though a court might order child support payments, the unfortunate statistics associated with the non-custodial spouse making such payments in the United States speak for themselves.

Besides the personal carnage associated with a divorce, there are severe financial consequences for those around the divorcing couple. These consequences extend beyond the divorcing parties and their family or families. For instance, significant amounts of lost employee productivity can be associated with an employee undergoing a divorce.

In the United States, the judicial system generally administers family law matters such as divorces. The court (or a court ordered commission) splits the marital estate and decides who gets the children, the assets, the liabilities and who gets to pay child support and alimony. This leads the more well to do to do things such as hide assets off shore, pauper themselves, and so forth. Despite its best efforts, the judicial system leaves much to be desired in this highly personal and charged situation.

Besides the judicial system, people have tried various private methods to protect what they perceive to be their assets from the former spouse. Such private means have included prenuptial agreements, trusts, alternate dispute resolution, such as mediation, for splitting the marital property, etc.

At the same time, present day society offers plenty of possibilities to insure oneself or a legal entity for many a mishap or many a risk. Such insurance policies are rationally based on statistics and/or demographics. Phenomena that tend to occur with a certain incidence and which are associated with (financial) risk are insured for an amount that allows an insurance or other company that has many such insurance policies to be able to remunerate the legal entities or persons which encounter such a phenomenon. Some phenomena are insured through monthly payments of fees, thereby allowing insurance companies to rely on time factors as well as on number of occurrence. Theft, fire, breech of contract, life, car, education, health and many other aspects of life can be insured.

### SUMMARY OF THE INVENTION

It would a significant improvement to the well-being of many if the risk of divorce or split up of a couple could be spread over a larger group of people, such as is the situation with health or life insurance.

Insurance policies suitable for adaptation so as to be applied with the invention are known in themselves and many of the terms and conditions of such policies can be transferred from such policies by those skilled in the art of providing insurance. The present invention applies the principle of insurance to the field of contracts between natural persons, in particular contracts such as marriages or contracts governing a situation wherein two or more people live together (e.g., a cohabitation agreement between a same sex couple).

The present invention provides insurance against the financial consequences of the ending of a contractual relationship between natural persons, in particular those contracts which govern their way of living together, more in particular the ending of marriages and the like, in particular by divorce. For brevity, the foregoing will be referred to as insurance policies for divorce. Divorce is a typical phenomenon of which the demographics are well known and of which the financial consequences can be fairly well predicted. Therefore, the risk associated with insurance against divorce can be very well determined.

Accordingly, the invention includes a method of doing business involving providing insurance for divorce.

The invention also includes a computer program for administering the divorce insurance of the present invention.

Although the concept may sound cynical, the advantages of such a system are many fold to both the insured parties and to society in general. For society, by taking the responsibility for payment away from the parties (or the state) there should be an increased certainty that child support payments will actually be made, thus decreasing the burden on taxpayers. For the individuals involved, there is no need to beggar one or both spouses unnecessarily which should hopefully decrease the bitterness between the divorcing couple. Also, there should be a decreased amount of consternation normally caused by making substantial monthly payments to an ex-spouse.

### DETAILED DESCRIPTION OF THE INVENTION

An insurance policy (or a functional equivalent thereof, such as a savings account for the later unfortunate event) for the compensation of financial consequences of ending a marriage by divorce can be pretty simple. It can consist of only one installment (which will typically be rather high) of weekly, monthly or yearly (or any other term) installments. They can start at the day of marriage or before or during a marriage (or another such contract). They can be entered into by the (future) contract partners, or by entities wishing to provide at least one such a (future) contract partner with such an insurance. They can be entered into at any age of the (future) contract parties.

The monies paid can be purely fees for the insured financial risks, but they can also be (partially) investments in stock and the like, which may provide for a sum to be paid at a certain end date of the insurance policy. Such an end date may be the event that was insured, but it may also be a certain duration of the contractual relationship, or the reaching of a certain age of a contract partners or both partners. It may also be the passing away of one of the partners. This way the insurance policy becomes part of another (life) insurance policy. In similar ways the insurance policy can be part of another insurance policy or comprise (parts of) other insurance policies.

The insurance policy of the invention may also comprise other contractual arrangements or made part of another contract such as an employment contract (e.g., offered as an employee benefit).

The financial consequences to be covered can be made simply through a fixed payment of an amount of money, or by, for example, reimbursement of legal fees, covering moving costs, making alimony payments or children support payments (e.g., for children resulting from the contractual relationship) or a combination of the above and similar costs to be expected.

The monies required to be paid for such an insurance depends on many different parameters. It depends on the age at which the policy is entered. It depends on the demographics of the area where the contract partners are.

The amount to be charged depends on several items associated with the value of the policy. For instance, it could depend on the age of the contracting partners. It could depends on the investments to be made and historical returns on investments, etc. Once apprized of the invention, people of skill in the art in designing insurance policies will be capable of designing suitable policies and using them. As a simple example, any personal insurance giving payment at a certain age can be modified to accommodate the invention.

The amount to be charged (i.e., the premium) could be increased as the number of children increases. The amounts for the premium could be decreased as a child passes a certain age (e.g., 18 or 21 years). As with “universal life” polices, the premiums could be refunded if there were no divorce by a certain, predetermined age of the insured (e.g., 55, 60, or 65 or any other suitable age to be determined by the particular circumstances).

The invention preferably involves a method of doing business which includes determining a periodic (e.g., monthly, semi-annually or annually) amount to be charged a prospective participant for divorce insurance; charging that periodic amount (or “premium”) to a participant in an insurance program over a period of time; and administering the insurance program (e.g., confirm that a divorce has or has not occurred, receiving and making payments, etc.)

The amount to be charged a prospective participant will generally be based upon the prospective participant's age and the prospective participant's spouse's age, both at the time of the marriage and at the time of paying the particular premium. The amount to be charged will also typically be based, in part, on the prospective participant's projected earnings and/or the prospective participant's spouse's projected earnings. The amount charged a participant can be changed in view of changed circumstances in the lifestyle (e.g., income or health) of the participant. Other changed circumstances include inflation, deflation, educational achievement of the participant or the participant's spouse, birth of a child, death of a child, disability of a participant, disability of a spouse, return on investment of investments made with the periodic amounts, and any combination thereof.

Analysis for socioeconomic/demographic factors of the couple (e.g., age, age difference between the respective members of the couple, educational backgrounds, previous marital status, health of the respective partners, whether or not the couple already has children), projected inflation rate over the life of the policy, projected investment return over the life of the policy, assets of the respective partners, and life styles to which the members of the couple have become accustomed or will likely be accustomed can be conducted by the insurance company. For example, people with less chance of a divorce could be charged a lower premium.

The policy could be sold to prospective participants in the usual ways for selling life insurance. For example, insurance salesmen could offer it to new couples. The policy may also be combined with disability or life insurance. In one embodiment, the policy could include a death benefit to a spouse in the event the spouse is left widowed. In another embodiment, the policy could be offered or provided as an employee benefit. It could also be coordinated with a retirement plan or plans so that if the couple does not separate, the premiums (or a portion thereof) are refunded to the insured.

Once determined and collected, at least a portion of the periodic amount will be invested by the insurance company in appropriate investments. Such investments are well known to those of skill in the art, but generally include, stocks, bonds, bank accounts, fixed income investments, venture capital investments, and so forth. Once invested, the collected funds should grow for eventual distribution to either participants or owners of the insurance company.

In order to collect on the policy, satisfactory proof of divorce (e.g., certified copies of court documents) would preferably need to be provided to the insurance company (or otherwise collected by the insurance company) and certifications made to insure that the couple has actually physically separated before payment was made. Continuing certification that the couple remains separated could be required (e.g., annually) before payments under the policy are continued. If a couple re-marries, a refund of at least some of the payments made could be required, although this is not necessary in all embodiments and circumstances.

Payments on behalf of the participant (e.g., to the child or former partner or spouse) would be preferably made over time, with few or no lump sum payments thus decreasing the impetus for any fraud. The requirement to pay premiums could be continued after the divorce or separation not unlike health insurance premiums. Payments for child support preferably cease when a child reaches 18 or 21 (if the child attends post-secondary education, for example, goes to college). Alimony payments could cease or be reduced when the former partner gets a job or re-marries.

Further, the policy need not necessarily provide the sole means of support for a non-wage earner former partner or spouse. The policy may be acquired just to ensure that the lifestyle of this former spouse and any children do not fall below a pre-determined level. The payments could also be made to educate or re-train a former partner for a life without the financial aid of the other partner.

Upon payout, the policy would preferably pay for child support, alimony, children's or former partner's education, other maintenance of a former partner or spouse (e.g., health and life insurance premiums), etc.

As with all insurance policies, the policy of the instant invention has a potential for abuse (e.g., by fraud). Preferably, the policy will include contractual features to prevent such fraud. For instance, the policy could include a waiting period (e.g., three (5) to five (5) years or any other time period) before the policy becomes effective. If the couple separates earlier than the time period, premiums could be refunded with or without interest. Furthermore, if the couples remarries or cohabitates for a long time period after separation or divorce, payments should cease and perhaps repayment made to the insurer.

As with most businesses nowadays, the offering and administration of the program could be administered and operated as an on-line business.

In one embodiment, the insurance policy is administered with the aid of a computer or computers and associated software. Such software, which will be more thoroughly described herein, will typically run on a main frame or other commercially available computer. It will typically be used to print up the policy on a commercially available printer.

During the application process, a computerized form will typically be required to filled out by the prospective participants. The data from the form can be utilized by the computer to determine a periodic amount.

The computer's software preferably includes means for determining a periodic amount to be charged a prospective participant for divorce insurance. It also preferably includes means for charging that periodic amount to a participant in an insurance program over a period of time (e.g., by printing and sending bills or invoices and receiving payments). It will also preferably include means for administering the insurance program.

For instance, in determining the amount to be charged, the software can determine the amount to be charged a prospective participant based, at least in part, on the prospective participant's age and the prospective participant's partner's age. The software can also determine the amount to be charged based, in part, on the prospective participant's projected earnings or on the prospective participant's partner's projected earnings. The computer software can also determine the amount to be charged based on the regularity of the periodic payments (e.g., monthly, quarterly, semi-annually, or annually).

The amount to be charged a participant can change in view of changed circumstances in the participant's life or environment. For example, the computer software can receive and interpret information such as prevailing interest rates, the inflation rate, the deflation situation, the economic perspective, or, on a more personal level, educational achievement of the participant or the participant's partner or child, birth of a child, death of a child, disability of a participant, disability of a partner, return on investment of investments made with the periodic amounts, and any combination thereof.

The computer can also be used to determine the amount to be paid out under the policy. For example, it can take the foregoing information into consideration and be used to determine what sort of support a former spouse or partner needs dependent on general and specific circumstances (e.g., rent or house payments, health of the former partner and any children, educational requirement of the former partner and any children, cost of living, etc.)

The software or computer can also be used to assist in investing at least a portion of the periodic amount.

It can also be used to administer the program by, for example, including names and relevant information in a database (which are commercially available).

The invention is explained by the following illustrative Examples:

### EXAMPLES

### Example I

In one example, a couple to be married approaches a life insurance sales representative. Each member of the couple is 25 years old and healthy. The programmed computer is used to calculate a premium for a policy for the next five years. The calculation is based upon the projected inflation rate and projected rate of return on investment. The monthly amount to be charged is “X”, with a five year waiting period before the policy vests. The amount of the premium is to be re-calculated every five years.

Five years later, the couple is still married, and has a one year old child. The insurance company has received 60× in premium payments which have been invested by the insurance company. At this point in time, the insurance company uses the programmed computer to re-calculate the premium to be charged for the couple based upon updated information (both personal to the couple and generally with respect to, for example, economic projections). The new monthly payment is X+x′.

Five years later, the couple is still married, and a second child three years younger than the first. The insurance company has received 60× plus 60(X+x′) in premium payments and has continued to invest the premiums. Again, at this point in time, the insurance company uses the programmed computer to once again re-calculate the premium to be charged for the couple based upon updated information (both personal to the couple and generally with respect to, for example, economic projections). The new monthly payment is X+x″.

Five years later, the couple is still married. Both members of the couple are 40 years of age. The first child is 11 and the second is 8. The insurance company has received 60× plus 60(X+x′) plus 60(X+x″) in premium payments and has continued to invest the premiums. Again, at this point in time, the insurance company uses the programmed computer to once again recalculate the premium to be charged for the couple based upon updated information. The new monthly payment is X+x”“.

Five years later, the couple is still married. Both members of the couple are 45 years of age. The first child is 16 and the second is 13. The insurance company has received 60× plus 60(X+x′) plus 60(X+x″) plus 60(X+x″′) in premium payments and has continued to invest the premiums. Again, at this point in time, the insurance company uses the programmed computer to once again re-calculate the premium to be charged for the couple based upon updated information. The new monthly payment is X+x”“.

Two years later, the couple has divorced. Both members of the couple are 47 years of age. The first child is 18 and the second is 15. The insurance company has received 60× plus 60(X+x′) plus 60(X+x″) plus 60(X+x″′) and 24(X+x”“) in premium payments and has continued to invest the premiums. The oldest child is going to college. The spouse who stayed at home has lost most job skills due to being at home for 18 years taking care of the children and will need to be re-trained. The departing partner will need to maintain a separate household which is to be paid from, for example, his own income. Again, the insurance company uses the programmed computer to determine the amount to be paid out to the former couple for child maintenance (including some support expenses for the child who is attending college) and maintenance of the spouse (including re-training). Payments are made from the invested premiums and the invested premiums of others. The insurance company continues to collect premiums (at a rate of X+x”“) as a condition of making further payments to the former couple. After three more years, the insurance company uses the programmed computer to once again re-calculate the premium to be charged for the couple based upon updated information

### Example II

In another scenario, instead of divorcing, the couple stays together, the premiums are collected and invested. After the couple has reached, for example, 60 years of age, the premiums are refunded (interest free), and the insurance company keeps the interest.

### Example III

In another scenario, the policy is combined with a life insurance policy paid for by one of the partner's employers. That partner dies at age 45, and the policy converts to a life insurance policy paying a benefit to the surviving partner and any children.

Although the invention has been described with some degree of particularity in order to thoroughly explain it, after being apprized of the invention, those of skill in the art will be able to adapt it from the particular details given herein without departing from its full scope.

What is claimed is:

1. An insurance policy covering at least some financial consequences of the untimely ending of a contractual relationship between two or more natural persons, which contractual relationship governs the natural persons way of living together.

2. The insurance policy of claim 1, wherein said contractual relationship is a marital contract.

3. The insurance policy of claim 2, wherein said untimely ending comprises a divorce between the natural persons.

4. The insurance policy of claim 1, wherein said insurance policy combines said some financial consequences of the untimely ending of a contractual relationship between natural persons with other financial risks such as the passing away of one of the contractual partners.

5. The insurance policy of claim 1, wherein said policy is part of another contract, such as an employment contract or a prenuptial contract.

6. The insurance policy of claim 1, comprising a clause providing a payment at an end date of the policy in the event the contractual relationship does not end untimely.

7. The insurance policy of claim 6, wherein said payment is dependent on investment of installments paid on behalf of said natural persons for said insurance policy.

8. The insurance policy of claim 1, requiring periodical installments.

9. The insurance policy of claim 1, comprising a clause for a minimum duration of the subject contractual relationship before any coverage is obtained.

10. The insurance policy of claim 1, comprising a clause limiting coverage for a certain time interval after the initiation of said contractual relationship.

11. The insurance policy of claim 1, which is taken by an entity not being a party to said contractual relationship.

12. A method of doing business comprising:
determining a periodic amount to be charged a prospective participant for divorce insurance;
charging that periodic amount to a participant in an insurance program over a period of time; and
administering the insurance program.

13. The method according to claim 12 wherein the amount to be charged a prospective participant is based, in part, on the prospective participant's age and the prospective participant's partner's age.

14. The method according to claim 12 wherein the amount to be charged is based, in part, on the prospective participant's projected earnings.

15. The method according to claim 12 wherein the amount to be charged is based, in part, on the prospective participant's partner's projected earnings.

16. The method according to claim 12 wherein the amount charged a participant is changed in view of changed circumstances in the participant's life.

17. The method according to claim 16 wherein the changed circumstances are selected from the group of inflation, deflation, educational achievement of the participant or the participant's partner, birth of a child, death of a child, disability of a participant, disability of a partner, return on investment of investments made with the periodic amounts, and any combination thereof.

18. The method according to claim 12 wherein the periodic amount is a monthly amount.

19. The method according to claim 12 wherein administering the program involves investing at least a portion of the periodic amount.

20. The method according to claim 12 further comprising means to prevent fraud.
